(19) United States
(12) Patent Application Publication
(10) Pub. No.: US 2026/0371052 A1
(43) Pub. Date: Nov. 19, 2026

(54) BLUETOOTH CONTROLLER CIRCUIT FOR INCREASING MAXIMUM NUMBER OF SIMULTANEOUS BLUETOOTH CONNECTIONS

(71) Applicant: Realtek Semiconductor Corp., Hsinchu (TW)

(72) Inventors: Kuan-Chung HUANG, Hsinchu (TW); Chia Chun HUNG, Hsinchu (TW); Hong-Ruei CHEN, Hsinchu (TW); Mu-Hua CHEN, Hsinchu (TW)

(73) Assignee: Realtek Semiconductor Corp., Hsinchu (TW)

(21) Appl. No.: 19/676,552

(22) Filed: May 13, 2026

Related U.S. Application Data
(60) Provisional application No. 63/805,462, filed on May 14, 2025.

(30) Foreign Application Priority Data
Mar. 17, 2026 (TW) 115110066

(51) Int. Cl. H04W 4/80

(52) U.S. Cl. CPC H04W 4/80

(57) ABSTRACT

A Bluetooth controller circuit includes: a first Bluetooth processing circuit arranged for operably conducting Bluetooth communications with a first Bluetooth slave device via a radio frequency (RF) circuit; a second Bluetooth processing circuit arranged for operably conducting Bluetooth communications with a second Bluetooth slave device via the radio frequency circuit; a packet traffic arbitration circuit arranged for operably coordinating the timing of access to the radio frequency circuit by the first and second Bluetooth processing circuits; and a control circuit arranged for operably controlling the operations of the first Bluetooth processing circuit, the second Bluetooth processing circuit, and the packet traffic arbitration circuit, and arranged for operably generating a traffic priority configuration command corresponding to multiple Bluetooth connections between the Bluetooth controller circuit and a plurality of Bluetooth slave devices.

### CROSS-REFERENCE TO RELATED APPLICATIONS

This application claims the benefit of priority to Patent Application No. 115110066, filed in Taiwan on Mar. 17, 2026; the entirety of which is incorporated herein by reference for all purposes.

This application claims the benefit of priority to U.S. Provisional Application Ser. No. 63/805,462, filed on May 14, 2025; the entirety of which is incorporated herein by reference for all purposes.

### BACKGROUND

The disclosure generally relates to Bluetooth communication technologies, and more particularly, to a Bluetooth controller circuit capable of increasing a maximum number of Bluetooth slave devices that may simultaneously connect with a Bluetooth host device.

Bluetooth technologies may generally be categorized into two main types. One type is the Basic Rate/Enhanced Data Rate (BR/EDR) technology, which is also referred to as the Classic Bluetooth or Legacy Bluetooth technology. Another type is the Bluetooth Low Energy (BLE) technology. Although the BLE technology has been developed relatively more recently, the BLE technology is still unable to fully replace the Classic Bluetooth technology in many practical applications, especially in applications having higher requirements regarding transmission bandwidth and/or connection stability.

However, according to specifications of existing Classic Bluetooth communication standards, when one device serves as a Bluetooth master device, the Active Member Address (AM_ADDR) that may be allocated to Bluetooth slave devices is defined as having only three bits. After deducting one address reserved for special purposes, the number of valid addresses that may actually be allocated to different slave devices is only seven. As a result, a Bluetooth host device adopting the Classic Bluetooth technology may only simultaneously maintain connections with at most seven slave devices. The aforementioned limitation on the number of simultaneously connected devices may constitute a significant technical obstacle for applications that require a Bluetooth master device to simultaneously maintain Bluetooth connections with a greater number of slave devices.

### SUMMARY

An example embodiment of a Bluetooth controller circuit for serving as a communication bridge between a Bluetooth host device and a plurality of Bluetooth slave devices is disclosed. The plurality of Bluetooth slave devices comprises a first Bluetooth slave device and a second Bluetooth slave device. The Bluetooth controller circuit comprises: an interface circuit, arranged to operably communicatively couple with the Bluetooth host device and conduct signal transmissions with the Bluetooth host device, and arranged to operably perform a physical-layer signal processing operation so as to cause the Bluetooth host device to identify the Bluetooth controller circuit as a single Bluetooth controller; an interface conversion circuit, communicatively coupled with the interface circuit, and arranged to operably convert data from the Bluetooth host device into another data format so as to generate target-format data; a storage circuit; a direct memory access circuit, communicatively coupled with the interface conversion circuit and the storage circuit, and arranged to operably store the target-format data generated by the interface conversion circuit into the storage circuit, and to perform various data transfer operations between the storage circuit and internal components of the Bluetooth controller circuit; a first Bluetooth processing circuit, communicatively coupled with a radio frequency circuit, and arranged to operably conduct Bluetooth communications with the first Bluetooth slave device through the RF circuit; a second Bluetooth processing circuit, communicatively coupled with the RF circuit, and arranged to operably conduct Bluetooth communications with the second Bluetooth slave device through the RF circuit; a packet traffic arbitration circuit, communicatively coupled with the first Bluetooth processing circuit and the second Bluetooth processing circuit, and arranged to operably coordinate timings at which the first and second Bluetooth processing circuits access the RF circuit; and a control circuit, communicatively coupled with the interface circuit, the interface conversion circuit, the storage circuit, the direct memory access circuit, the first Bluetooth processing circuit, the second Bluetooth processing circuit, and the packet traffic arbitration circuit, and arranged to operably control operations of the interface circuit, the interface conversion circuit, the storage circuit, the direct memory access circuit, the first Bluetooth processing circuit, the second Bluetooth processing circuit, and the packet traffic arbitration circuit; wherein the control circuit is further arranged to operably monitor traffic loads of multiple Bluetooth connections between the Bluetooth controller circuit and the plurality of Bluetooth slave devices, and to generate a traffic priority configuration command corresponding to the multiple Bluetooth connections.

Both the foregoing general description and the following detailed description are examples and explanatory only, and are not restrictive of the invention as claimed.

### BRIEF DESCRIPTION OF THE DRAWINGS

FIG. 1 shows a simplified functional block diagram of a Bluetooth communication system according to a first embodiment of the present disclosure.

FIG. 2 shows a simplified functional block diagram of a Bluetooth communication system according to a second embodiment of the present disclosure.

FIG. 3 shows a simplified functional block diagram of a Bluetooth communication system according to a third embodiment of the present disclosure.

### DETAILED DESCRIPTION

Embodiments of the present disclosure will be described below in conjunction with the related drawings. In the drawings, the same reference numerals are used to indicate the same or similar elements or method flows.

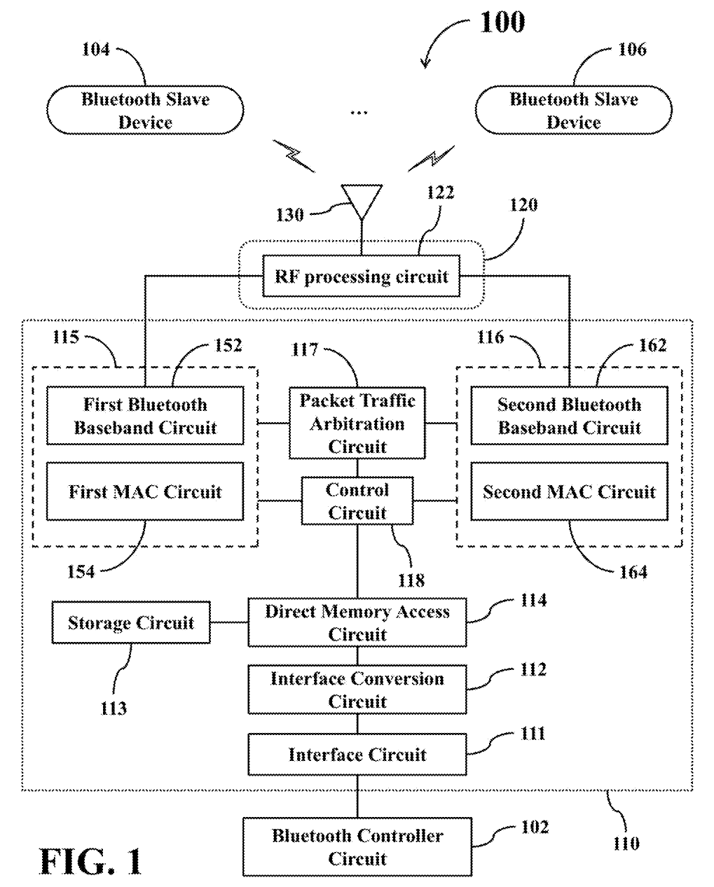

FIG. 1 shows a simplified functional block diagram of a Bluetooth communication system 100 according to the first embodiment of the present disclosure. The Bluetooth communication system 100 may comprise a Bluetooth host device 102, a plurality of Bluetooth slave devices (in FIG. 1, only Bluetooth slave devices 104 and 106 are illustrated as examples to simplify the complexity of the drawing), a Bluetooth controller circuit 110, a radio frequency (RF) circuit 120, and a first antenna 130. When the Bluetooth host device 102 attempts to simultaneously establish Bluetooth connections with multiple Bluetooth slave devices, the Bluetooth controller circuit 110 may process and schedule related Bluetooth packets, and may conduct Bluetooth signal transmissions between the Bluetooth controller circuit 110 and the respective Bluetooth slave devices through the RF circuit 120 and a related antenna.

As shown in FIG. 1, the Bluetooth controller circuit 110 may comprise an interface circuit 111, an interface conversion circuit 112, a storage circuit 113, a direct memory access circuit 114, a first Bluetooth processing circuit 115, a second Bluetooth processing circuit 116, a packet traffic arbitration circuit 117, and a control circuit 118.

The interface circuit 111 is communicatively coupled with the Bluetooth host device 102, and may be arranged to operably conduct signal transmissions with the Bluetooth host device 102 and to perform a physical-layer signal processing operation, so as to cause the Bluetooth host device 102 to identify the Bluetooth controller circuit 110 as a single Bluetooth controller. In operation, the interface circuit 111 may exchange physical-layer signals with the Bluetooth host device 102 to perform various data handshaking operations with the Bluetooth host device 102.

The interface conversion circuit 112 is communicatively coupled with the interface circuit 111, and may be arranged to operably handle data conversion between different communication protocols, so as to convert data from the Bluetooth host device 102 into another data format to generate target-format data. In addition, the interface conversion circuit 112 may further be arranged to operably convert data generated by the first Bluetooth processing circuit 115, the second Bluetooth processing circuit 116, and/or the control circuit 118 into a data format required by the Bluetooth host device 102.

The direct memory access circuit 114 is communicatively coupled with the interface conversion circuit 112 and the storage circuit 113, and may be arranged to operably store the target-format data generated by the interface conversion circuit 112 into the storage circuit 113, and to perform various high-speed data transfer operations between the storage circuit 113 and internal components of the Bluetooth controller circuit 110, so as to improve data transfer efficiency.

The first Bluetooth processing circuit 115 is communicatively coupled with the RF circuit 120, and may be arranged to operably conduct Bluetooth communications with a portion of the aforementioned plurality of Bluetooth slave devices (e.g., the first Bluetooth slave device 104) through the RF circuit 120.

The second Bluetooth processing circuit 116 is communicatively coupled with the RF circuit 120, and may be arranged to operably conduct Bluetooth communications with another portion of the aforementioned plurality of Bluetooth slave devices (e.g., the second Bluetooth slave device 106) through the RF circuit 120.

The first Bluetooth processing circuit 115 and the second Bluetooth processing circuit 116 may be utilized as two independent cores for handling various Bluetooth transmission operations between the Bluetooth controller circuit 110 and the plurality of Bluetooth slave devices.

The packet traffic arbitration circuit 117 is communicatively coupled with the first Bluetooth processing circuit 115 and the second Bluetooth processing circuit 116, and may be arranged to operably coordinate timings at which the first Bluetooth processing circuit 115 and the second Bluetooth processing circuit 116 access the RF circuit 120. In operation, the packet traffic arbitration circuit 117 may be utilized to coordinate the access rights or access requests of both the first Bluetooth processing circuit 115 and the second Bluetooth processing circuit 116 with respect to the RF circuit 120.

The control circuit 118 is communicatively coupled with the interface circuit 111, the interface conversion circuit 112, the storage circuit 113, the direct memory access circuit 114, the first Bluetooth processing circuit 115, the second Bluetooth processing circuit 116, and the packet traffic arbitration circuit 117, and may be arranged to operably control operations of the aforementioned circuits.

In the embodiment of FIG. 1, the first Bluetooth processing circuit 115 may comprise a first Bluetooth baseband circuit 152 and a first media access control circuit 154, the second Bluetooth processing circuit 116 may comprise a second Bluetooth baseband circuit 162 and a second media access control circuit 164, and the RF circuit 120 may comprise an RF processing circuit 122.

Both the first Bluetooth baseband circuit 152 and the second Bluetooth baseband circuit 162 are communicatively coupled with the RF circuit 120, and may be respectively arranged to operably perform a baseband signal processing. The first media access control circuit 154 is communicatively coupled with the first Bluetooth baseband circuit 152, and the second media access control circuit 164 is communicatively coupled with the second Bluetooth baseband circuit 162. Both the first media access control circuit 154 and the second media access control circuit 164 may be arranged to operably perform packet formatting and time-slot timing control compliant with the Basic Rate/Enhanced Data Rate (BR/EDR) specifications. In other words, the first media access control circuit 154 and the second media access control circuit 164 may both be media access control circuits capable of supporting the Classic Bluetooth (or Legacy Bluetooth) technology.

When the first Bluetooth processing circuit 115 attempts to transmit Bluetooth signals to a corresponding Bluetooth slave device through the RF circuit 120, the first Bluetooth baseband circuit 152 may convert digital packets generated by the first media access control circuit 154 into baseband signals suitable for wireless transmission, and the RF processing circuit 122 in the RF circuit 120 may then process the baseband signals from the first Bluetooth baseband circuit 152, so as to convert the baseband signals into electromagnetic waves complying with a Bluetooth frequency band and to transmit the electromagnetic waves through the first antenna 130. When the first antenna 130 receives Bluetooth signals transmitted from the corresponding Bluetooth slave device, the RF processing circuit 122 may perform various processing operations, including filtering, low-noise amplification, and demodulation, on the Bluetooth signals received by the first antenna 130, and may provide the processed signals to the first Bluetooth baseband circuit 152.

Similarly, when the second Bluetooth processing circuit 116 attempts to transmit Bluetooth signals to a corresponding Bluetooth slave device through the RF circuit 120, the second Bluetooth baseband circuit 162 may convert digital packets generated by the second media access control circuit 164 into baseband signals suitable for wireless transmission, and the RF processing circuit 122 in the RF circuit 120 may then process the baseband signals from the second Bluetooth baseband circuit 162, so as to convert the baseband signals into electromagnetic waves complying with the Bluetooth frequency band and to transmit the electromagnetic waves through the first antenna 130. When the first antenna 130 receives Bluetooth signals transmitted from the corresponding Bluetooth slave device, the RF processing circuit 122 may perform various processing operations, including filtering, low-noise amplification, and demodulation, on the Bluetooth signals received by the first antenna 130, and may provide the processed signals to the second Bluetooth baseband circuit 162.

As may be appreciated from the foregoing descriptions, the first media access control circuit 154 may access the RF processing circuit 122 in the RF circuit 120 through the first Bluetooth baseband circuit 152, and the second media access control circuit 164 may access the RF processing circuit 122 in the RF circuit 120 through the second Bluetooth baseband circuit 162.

During a process in which the Bluetooth host device 102 conducts Bluetooth transmissions with the plurality of Bluetooth slave devices through the Bluetooth controller circuit 110, the control circuit 118 may monitor traffic loads of multiple Bluetooth connections between the Bluetooth controller circuit 110 and the plurality of Bluetooth slave devices, and may generate a traffic priority configuration command corresponding to the multiple Bluetooth connections. The packet traffic arbitration circuit 117 may, based on the traffic priority configuration command generated by the control circuit 118, control access priorities of the first Bluetooth processing circuit 115 and the second Bluetooth processing circuit 116 with respect to the RF circuit 120, and may schedule timings at which the first Bluetooth processing circuit 115 and the second Bluetooth processing circuit 116 access the RF circuit 120.

For example, in the embodiment of FIG. 1, the packet traffic arbitration circuit 117 may be arranged to operably, based on the traffic priority configuration command generated by the control circuit 118, control access priorities of the first media access control circuit 154 and the second media access control circuit 164 with respect to the RF processing circuit 122 in the RF circuit 120, and may schedule timings at which the first media access control circuit 154 and the second media access control circuit 164 access the RF processing circuit 122 in the RF circuit 120.

In implementation, the Bluetooth host device 102 may be implemented with various devices capable of supporting the Basic Rate/Enhanced Data Rate (BR/EDR) technology and capable of serving as a Bluetooth master device, for example, a desktop computer, a notebook computer, a tablet computer, a mobile phone, a smart television, or a smart speaker. The plurality of Bluetooth slave devices in the Bluetooth communication system 100 (for example, the Bluetooth slave devices 104 and 106 illustrated in FIG. 1) may be implemented with various devices capable of supporting the BR/EDR technology and capable of serving as a Bluetooth slave device, for example, a Bluetooth keyboard, a Bluetooth mouse, a Bluetooth game controller, a Bluetooth headset, a Bluetooth speaker, a Bluetooth wristband, Bluetooth eyewear, a Bluetooth wearable device, a Bluetooth head-mounted device, a mobile phone, a smart television, or various computers.

In the Bluetooth controller circuit 110, the interface circuit 111 may be implemented with various signal interface circuits compliant with related network communication, wired communication, or wireless communication specifications. For example, the interface circuit 111 may be implemented with one of, or a combination of multiple types among, various USB (Universal Serial Bus) interface circuits, UART (Universal Asynchronous Receiver-Transmitter) interface circuits, I2S (Inter-IC Sound) interface circuits, PCIe (Peripheral Component Interconnect Express) interface circuits, SATA (Serial ATA) interface circuits, and/or other various suitable wired or wireless transmission interfaces, all of which may include physical-layer transceiver circuits. The interface conversion circuit 112 may be implemented with various specific protocol translation engines or application-specific integrated circuits (ASICs) capable of bidirectionally converting between data formats supported by the interface circuit 111 and Bluetooth data formats. For example, in an embodiment in which the interface circuit 111 is implemented with a USB interface circuit, the interface conversion circuit 112 may be implemented with a USB/Bluetooth interface conversion circuit. For another example, in an embodiment in which the interface circuit 111 is implemented with a UART interface circuit, the interface conversion circuit 112 may be implemented with a UART/Bluetooth interface conversion circuit.

The storage circuit 113 may be implemented with various volatile memories and/or non-volatile memories. The direct memory access circuit 114 may be implemented with various suitable application-specific integrated circuits (ASICs) having multi-channel scheduling and data transmission capabilities. The packet traffic arbitration circuit 117 may be implemented with various combinational logic circuits having priority weight calculation functions. The control circuit 118 may be implemented with various packet processing circuits, digital arithmetic circuits, microprocessors, or application-specific integrated circuits having appropriate computing capabilities and capable of parsing and generating Bluetooth packets.

Both the first Bluetooth baseband circuit 152 and the second Bluetooth baseband circuit 162 may be implemented with various suitable circuits capable of converting digital packets into baseband signals suitable for wireless transmission, and capable of converting RF signals from the RF circuit 120 into a format that may be processed by a MAC-layer circuit. The circuit architectures of the first Bluetooth baseband circuit 152 and the second Bluetooth baseband circuit 162 may be completely identical, or may have differences depending on the requirements of the circuit application. Both the first media access control circuit 154 and the second media access control circuit 164 may be implemented with various MAC-layer circuits compliant with the Basic Rate/Enhanced Data Rate (BR/EDR) specifications, and may be utilized to operably perform link-layer operations compliant with the BR/EDR specifications. The circuit architectures of the first media access control circuit 154 and the second media access control circuit 164 may be completely identical, or may have differences depending on the requirements of the circuit application.

The different functional blocks in the aforementioned Bluetooth controller circuit 110 may be respectively implemented with different circuits, or may be integrated into a single circuit chip.

In addition, the RF processing circuit 122 in the RF circuit 120 may be implemented with various suitable circuits capable of processing RF signals, and may comprise various components such as a power amplifier, a low-noise amplifier, a mixer, a frequency synthesizer, and a filter.

As mentioned above, since the communication standard of the existing Classic Bluetooth technology limits the number of bits of the Active Member Address (AM_ADDR) in a Bluetooth packet header to only three bits, an existing Bluetooth host device adopting the Classic Bluetooth technology may at most simultaneously maintain Bluetooth connections with up to seven Bluetooth slave devices. Such a limitation may significantly limit the application flexibility of existing Bluetooth host devices.

In order to enable the Bluetooth host device 102 to simultaneously maintain Bluetooth connections with more than seven Bluetooth slave devices, the Bluetooth controller circuit 110 in the embodiment of FIG. 1 is provided with two sets of independently operable Bluetooth processing circuits (i.e., the first Bluetooth processing circuit 115 and the second Bluetooth processing circuit 116). When the Bluetooth host device 102 needs to simultaneously maintain Bluetooth connections with more than seven Bluetooth slave devices, the Bluetooth controller circuit 110 may activate an internal traffic distribution mechanism.

In such a situation, the control circuit 118 may divide multiple Bluetooth connections between the Bluetooth host device 102 and the plurality of Bluetooth slave devices into two groups, such that the number of Bluetooth connections in each group does not exceed seven. The control circuit 118 may allocate one of the groups of Bluetooth connections to the first Bluetooth processing circuit 115 for processing, and may allocate the other group of Bluetooth connections to the second Bluetooth processing circuit 116 for processing. The control circuit 118 may instruct the first media access control circuit 154 and the second media access control circuit 164 to respectively use two sets of independent Active Member Address allocation logics. In addition, the control circuit 118 may further respectively provide different frequency-hopping parameters to the first media access control circuit 154 and the second media access control circuit 164, and may instruct the first media access control circuit 154 and the second media access control circuit 164 to respectively and independently generate and maintain a hopping sequence of the first media access control circuit 154 and a hopping sequence of the second media access control circuit 164, such that the first Bluetooth processing circuit 115 and the second Bluetooth processing circuit 116 may simultaneously maintain two sets of independently operating piconets compliant with the Basic Rate/Enhanced Data Rate (BR/EDR) specifications.

In the embodiment of FIG. 1, the RF circuit 120 may transmit and receive Bluetooth signals between the RF circuit 120 and multiple Bluetooth slave devices through the first antenna 130. Therefore, the first Bluetooth processing circuit 115 and the second Bluetooth processing circuit 116 may share the single antenna 130 through the RF circuit 120. During a process in which the first Bluetooth processing circuit 115 and the second Bluetooth processing circuit 116 respectively process one or more Bluetooth connections for which the first Bluetooth processing circuit 115 and the second Bluetooth processing circuit 116 are responsible, the control circuit 118 may monitor traffic loads of multiple Bluetooth connections between the Bluetooth controller circuit 110 and the plurality of Bluetooth slave devices, and may generate a traffic priority configuration command corresponding to the multiple Bluetooth connections. The packet traffic arbitration circuit 117 may, based on the traffic priority configuration command generated by the control circuit 118, control access priorities of both the first media access control circuit 154 and the second media access control circuit 164 with respect to the RF processing circuit 122 in the RF circuit 120, and may schedule timings at which the first media access control circuit 154 and the second media access control circuit 164 access the RF processing circuit 122 in the RF circuit 120.

For example, the packet traffic arbitration circuit 117 may use a time-slot as a basic switching unit to perform packet traffic arbitration. When both the first media access control circuit 154 and the second media access control circuit 164 have access requests for the same target time-slot, the packet traffic arbitration circuit 117 may, based on the traffic priority configuration command generated by the control circuit 118, determine which one has higher transmission priority (for example, voice packets may have higher priority than general data packets, video streaming packets may have higher priority than voice packets, etc.), and may employ a time division multiplexing (TDM) mechanism to allocate the RF occupancy of the target time-slot to the media access control circuit having the higher transmission priority. For example, when a particular Bluetooth connection that the first media access control circuit 154 is responsible for has the higher transmission priority for the target time-slot, the packet traffic arbitration circuit 117 may allocate the RF occupancy of the target time-slot to the first media access control circuit 154, such that the first media access control circuit 154 may access the RF processing circuit 122 within the target time-slot.

From the perspective of the Bluetooth host device 102, the Bluetooth host device 102 may only need to issue commands and/or transmit data corresponding to the single Bluetooth controller identifier emulated by the interface circuit 111. The mapping of Active Member Addresses, the prevention of packet collisions, and the establishment and maintenance of two independent piconets, etc., may all be cooperatively performed by internal circuit components within the Bluetooth controller circuit 110 under the control of the control circuit 118. In other words, the Bluetooth host device 102 does not need to modify a hardware architecture of the Bluetooth host device 102 in order to simultaneously maintain Bluetooth connections with multiple Bluetooth slave devices through the Bluetooth controller circuit 110.

Therefore, although the number of Bluetooth connections that the first Bluetooth processing circuit 115 and the second Bluetooth processing circuit 116 each need to handle does not exceed seven, when both circuits operate in parallel simultaneously, the maximum number of Bluetooth connections that the Bluetooth controller circuit 110 may manage and simultaneously process may be increased to fourteen. In other words, by employing the aforementioned Bluetooth controller circuit 110, the Bluetooth host device 102 may simultaneously maintain Bluetooth connections with up to fourteen Bluetooth slave devices.

As may be appreciated from the foregoing descriptions, when three sets of independently operable Bluetooth processing circuits are provided in the Bluetooth controller circuit 110, the Bluetooth host device 102 may simultaneously maintain Bluetooth connections with up to twenty-one Bluetooth slave devices. Likewise, when four sets of independently operable Bluetooth processing circuits are provided in the Bluetooth controller circuit 110, the Bluetooth host device 102 may simultaneously maintain Bluetooth connections with up to twenty-eight Bluetooth slave devices.

Although providing multiple independently operable Bluetooth processing circuits in the Bluetooth controller circuit 110 may help increase the upper limit of the number of Bluetooth slave devices that the Bluetooth host device 102 may simultaneously maintain Bluetooth connections with, if any one of the Bluetooth processing circuits is over-utilized, this may cause the transmission bandwidth of the Bluetooth controller circuit 110 to fail to be maximized, and/or may cause local overheating to occur within the circuit. The transmission bandwidth of the Bluetooth controller circuit 110 may be a very important performance metric in many applications. On the other hand, if local overheating tends to occur in the Bluetooth controller circuit 110, this may also cause certain internal circuit components of the Bluetooth controller circuit 110 to age or deteriorate prematurely, thereby shortening the usable lifespan of the Bluetooth controller circuit 110. Evidently, both the issue of the transmission bandwidth of the Bluetooth controller circuit 110 failing to be maximized and the issue of local overheating in the Bluetooth controller circuit 110 may be technical problems that require proper resolution in certain application fields.

In order to solve or mitigate the aforementioned technical problems, so as to maximize the transmission bandwidth of the Bluetooth controller circuit 110 and/or reduce the likelihood of local overheating occurring in the Bluetooth controller circuit 110, the Bluetooth controller circuit 110 in the embodiment of FIG. 1 may, during a process in which the Bluetooth host device 102 conducts Bluetooth transmissions with one or more Bluetooth slave devices through the Bluetooth controller circuit 110, dynamically perform a Bluetooth connection redistribution operation.

In implementation, the control circuit 118 may, by means of active detection or by passively receiving instructions from the Bluetooth host device 102, ascertain or evaluate a current Bluetooth packet traffic load, a current transmission bandwidth requirement, and/or a current number of simultaneously connected Bluetooth slave devices of the Bluetooth controller circuit 110. The control circuit 118 may also receive notifications from the Bluetooth host device 102 or another temperature sensing circuit (not illustrated in the drawings), so as to ascertain or evaluate a current circuit temperature of the Bluetooth controller circuit 110.

For example, when at a first target time point a current Bluetooth packet traffic load of the Bluetooth controller circuit 110 is higher than a first predetermined threshold, the current transmission bandwidth requirement is higher than a first predetermined bandwidth, the current number of simultaneously connected Bluetooth slave devices is greater than a first predetermined number, and/or the current circuit temperature is higher than a first predetermined temperature, the control circuit 118 may dynamically perform a Bluetooth connection redistribution operation between the first Bluetooth processing circuit 115 and the second Bluetooth processing circuit 116 on the multiple current Bluetooth connections, so as to perform a load balancing operation between the first Bluetooth processing circuit 115 and the second Bluetooth processing circuit 116, such that the traffic loads borne by the first Bluetooth processing circuit 115 and the second Bluetooth processing circuit 116 may be more evenly distributed. For example, the control circuit 118 may reassign one or more Bluetooth connections originally being processed by one of the Bluetooth processing circuits (e.g., the first Bluetooth processing circuit 115) to the other Bluetooth processing circuit (e.g., the second Bluetooth processing circuit 116) for processing, or may instruct the first Bluetooth processing circuit 115 and the second Bluetooth processing circuit 116 to mutually exchange a portion of the Bluetooth connections handled by the first Bluetooth processing circuit 115 and the second Bluetooth processing circuit 116.

In this way, the Bluetooth traffic load of the Bluetooth controller circuit 110 may be prevented from being excessively concentrated on one of the first Bluetooth processing circuit 115 and the second Bluetooth processing circuit 116, which may in turn increase a total transmission bandwidth and/or a total data throughput of the Bluetooth controller circuit 110, and may also effectively avoid or mitigate the issue of local overheating in the Bluetooth controller circuit 110.

On the other hand, the Bluetooth packet traffic load, the transmission bandwidth requirement, the number of simultaneously connected Bluetooth slave devices, and/or the circuit temperature of the Bluetooth controller circuit 110 may change over time. Therefore, the control circuit 118 may periodically or intermittently perform Bluetooth connection redistribution operations. For example, when at a second target time point a current Bluetooth packet traffic load of the Bluetooth controller circuit 110 is lower than a second predetermined threshold, the current transmission bandwidth requirement is lower than a second predetermined bandwidth, the current number of simultaneously connected Bluetooth slave devices is less than a second predetermined number, and/or the current circuit temperature is lower than a second predetermined temperature, the control circuit 118 may also dynamically perform another Bluetooth connection redistribution operation between the first Bluetooth processing circuit 115 and the second Bluetooth processing circuit 116 on the multiple current Bluetooth connections, so as to alternately use one of the first Bluetooth processing circuit 115 and the second Bluetooth processing circuit 116 to bear all of the Bluetooth connections in a sequential manner. Specifically, the control circuit 118 may concentrate all current Bluetooth connections to be processed by the same Bluetooth processing circuit (e.g., the first Bluetooth processing circuit 115). At the same time, the control circuit 118 may turn off the other Bluetooth processing circuit (e.g., the second Bluetooth processing circuit 116), or may control the other Bluetooth processing circuit (e.g., the second Bluetooth processing circuit 116) to enter a sleep mode or a power-saving mode, so as to save the overall power consumption of the Bluetooth controller circuit 110, and to allow the other Bluetooth processing circuit (e.g., the second Bluetooth processing circuit 116) to rest and cool down.

Once the first Bluetooth processing circuit 115 that is bearing all of the Bluetooth connections has been continuously operating for a predetermined duration, or the Bluetooth packet throughput processed by the first Bluetooth processing circuit 115 has exceeded a predetermined threshold, the control circuit 118 may turn on the second Bluetooth processing circuit 116, or may control the second Bluetooth processing circuit 116 to enter a working mode. Subsequently, the control circuit 118 may reassign all current Bluetooth connections to the second Bluetooth processing circuit 116 for processing, and may turn off the first Bluetooth processing circuit 115, or may control the first Bluetooth processing circuit 115 to enter a sleep mode or a power-saving mode, so as to save the overall power consumption of the Bluetooth controller circuit 110 and to allow the first Bluetooth processing circuit 115 to rest and cool down. Likewise, once the second Bluetooth processing circuit 116 that is bearing all of the Bluetooth connections has been continuously operating for a predetermined duration, or the Bluetooth packet throughput processed by the second Bluetooth processing circuit 116 has exceeded a predetermined threshold, the control circuit 118 may turn on the first Bluetooth processing circuit 115, or may control the first Bluetooth processing circuit 115 to enter a working mode. Subsequently, the control circuit 118 may reassign all current Bluetooth connections to the first Bluetooth processing circuit 115 for processing, and may turn off the second Bluetooth processing circuit 116, or may control the second Bluetooth processing circuit 116 to enter a sleep mode or a power-saving mode, so as to save the overall power consumption of the Bluetooth controller circuit 110 and to allow the second Bluetooth processing circuit 116 to rest and cool down. Thereafter, the control circuit 118 may, in the manner described above, alternately use one of the first Bluetooth processing circuit 115 and the second Bluetooth processing circuit 116 to handle all current Bluetooth connections.

The aforementioned manner in which the control circuit 118 alternately uses one of the first Bluetooth processing circuit 115 and the second Bluetooth processing circuit 116 to bear all of the Bluetooth connections may effectively balance the utilization rates of both the first Bluetooth processing circuit 115 and the second Bluetooth processing circuit 116, and/or balance the thermal distribution of the Bluetooth controller circuit 110, may avoid heat being accumulated for a long period of time in partial circuit regions, and may therefore effectively avoid the issue of local overheating occurring in the Bluetooth controller circuit 110.

During a process of performing the Bluetooth connection redistribution operation, the control circuit 118 may synchronize the operating timings of both the first Bluetooth processing circuit 115 and the second Bluetooth processing circuit 116, and may instruct the packet traffic arbitration circuit 117 and the direct memory access circuit 114 to operate in coordination with the requirements of the Bluetooth connection redistribution operation, so as to avoid causing Bluetooth connection interruptions during the process of reassigning a Bluetooth connection to another Bluetooth processing circuit. In this way, an individual Bluetooth connection may be seamlessly switched between the first Bluetooth processing circuit 115 and the second Bluetooth processing circuit 116.

In implementation, the aforementioned second predetermined threshold may be set to 30%~50% of the first predetermined threshold, the aforementioned second predetermined bandwidth may be set to 30%~40% of the first predetermined bandwidth, the aforementioned second predetermined number may be set to 30%~60% of the first predetermined number, and the aforementioned second predetermined temperature may be set to 40%~60% of the first predetermined temperature.

In addition, the control circuit 118 may use only one of the aforementioned multiple judgment conditions as the basis for activating or switching a Bluetooth connection redistribution operation, or may simultaneously use two or more of the judgment conditions as the basis for activating or switching a Bluetooth connection redistribution operation.

As may be appreciated from the foregoing descriptions, by configuring two sets of independent Bluetooth processing circuits (i.e., the aforementioned first Bluetooth processing circuit 115 and second Bluetooth processing circuit 116) within the Bluetooth controller circuit 110, the upper limit on the number of Bluetooth slave devices with which the Bluetooth host device 102 may simultaneously maintain Bluetooth connections may break through the existing technical bottleneck and may be doubled from seven to as many as fourteen.

Furthermore, the Bluetooth host device 102 does not need to modify a hardware architecture of the Bluetooth host device 102 in order to simultaneously maintain Bluetooth connections with more than seven Bluetooth slave devices through the Bluetooth controller circuit 110. For manufacturers of the Bluetooth host device 102, this may significantly reduce the cost and engineering difficulty of incorporating the Bluetooth controller circuit 110.

In addition, during a process in which the Bluetooth host device 102 conducts Bluetooth transmissions with one or more Bluetooth slave devices through the Bluetooth controller circuit 110, the control circuit 118 may further dynamically perform a Bluetooth connection redistribution operation according to the current Bluetooth packet traffic load, the current transmission bandwidth requirement, the current number of simultaneously connected Bluetooth slave devices, and/or the current circuit temperature of the Bluetooth controller circuit 110.

When the current Bluetooth packet traffic load of the Bluetooth controller circuit 110 is higher than the first predetermined threshold, the current transmission bandwidth requirement is higher than the first predetermined bandwidth, the current number of simultaneously connected Bluetooth slave devices is greater than the first predetermined number, and/or the current circuit temperature is higher than the first predetermined temperature, the Bluetooth connection redistribution operation performed by the control circuit 118 may avoid the Bluetooth traffic load of the Bluetooth controller circuit 110 from being excessively concentrated on one of the Bluetooth processing circuits. Therefore, the total transmission bandwidth and/or the total data throughput of the Bluetooth controller circuit 110 may be increased, and the operational performance of the Bluetooth controller circuit 110 may be effectively improved.

On the other hand, when the current Bluetooth packet traffic load of the Bluetooth controller circuit 110 is lower than the second predetermined threshold, the current transmission bandwidth requirement is lower than the second predetermined bandwidth, the current number of simultaneously connected Bluetooth slave devices is less than the second predetermined number, and/or the current circuit temperature is lower than the second predetermined temperature, the control circuit 118 may again perform the Bluetooth connection redistribution operation, so as to alternately use one of the first Bluetooth processing circuit 115 and the second Bluetooth processing circuit 116 to bear all of the Bluetooth connections in a sequential manner, thereby saving the overall power consumption of the Bluetooth controller circuit 110.

Furthermore, the Bluetooth connection redistribution operation performed by the control circuit 118 may further effectively balance the utilization rates of both the first Bluetooth processing circuit 115 and the second Bluetooth processing circuit 116, and/or balance the thermal distribution of the Bluetooth controller circuit 110, and therefore may effectively avoid or mitigate the issue of local overheating occurring in the Bluetooth controller circuit 110, which may in turn ensure the reliability of the Bluetooth controller circuit 110 and may extend the usable lifespan of the Bluetooth controller circuit 110.

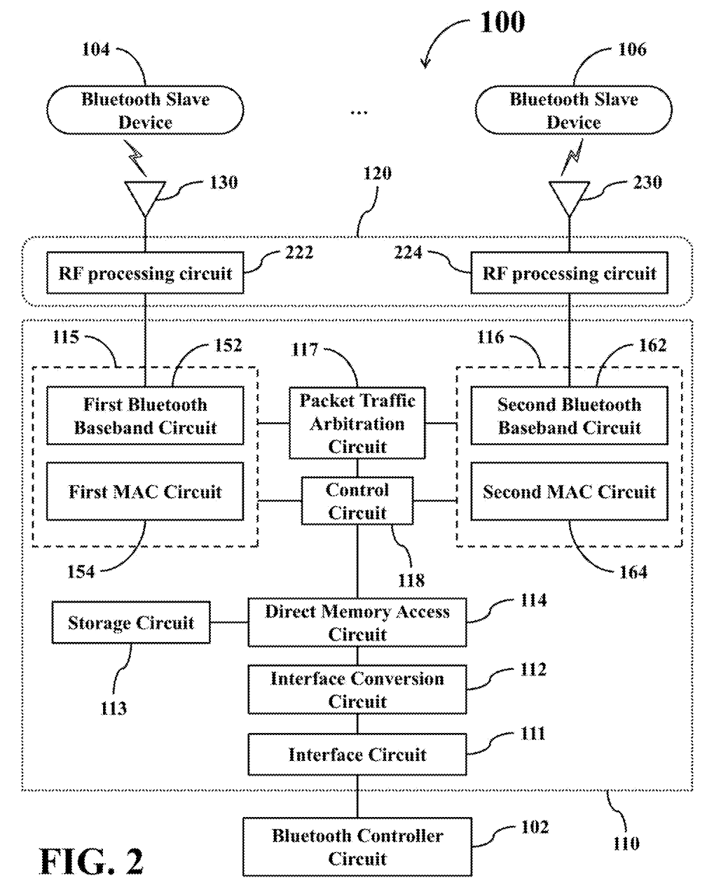

Please refer to FIG. 2, which shows a simplified functional block diagram of a Bluetooth communication system 100 according to a second embodiment of the present disclosure. The present embodiment is based on the architecture of the embodiment of FIG. 1, with hardware expansion and optimization performed on the RF front-end circuit, so as to further improve the Bluetooth transmission bandwidth and data throughput of the Bluetooth communication system 100.

In the embodiment of FIG. 2, the RF circuit 120 may comprise a first RF processing circuit 222 and a second RF processing circuit 224, which are respectively communicatively coupled with a first antenna 130 and a second antenna 230. In addition, the first Bluetooth baseband circuit 152 in the first Bluetooth processing circuit 115 is communicatively coupled with the first RF processing circuit 222, and the second Bluetooth baseband circuit 162 in the second Bluetooth processing circuit 116 is communicatively coupled with the second RF processing circuit 224. Therefore, the first media access control circuit 154 in the first Bluetooth processing circuit 115 may transmit and receive Bluetooth signals through the cooperative operation of the first RF processing circuit 222 and the first antenna 130, and the second media access control circuit 164 in the second Bluetooth processing circuit 116 may transmit and receive Bluetooth signals through the cooperative operation of the second RF processing circuit 224 and the second antenna 230.

In the present embodiment, the packet traffic arbitration circuit 117 may be configured to operably, based on the traffic priority configuration command generated by the control circuit 118, coordinate the schedules at which both the first media access control circuit 154 and the second media access control circuit 164 transmit and receive Bluetooth signals through the RF circuit 120, so as to suppress RF interference. For example, when the first media access control circuit 154 receives Bluetooth signals from a related Bluetooth slave device through the corresponding first RF processing circuit 222 and first antenna 130 within a first target time period (e.g., a first target time-slot), the packet traffic arbitration circuit 117 may prevent the second media access control circuit 164 from transmitting Bluetooth signals through the corresponding second RF processing circuit 224 and second antenna 230, so as to avoid interfering with the Bluetooth signal reception of the first RF processing circuit 222 and the first antenna 130. Similarly, when the second media access control circuit 164 receives Bluetooth signals from a related Bluetooth slave device through the corresponding second RF processing circuit 224 and second antenna 230 within a second target time period (e.g., a second target time-slot), the packet traffic arbitration circuit 117 may prevent the first media access control circuit 154 from transmitting Bluetooth signals through the corresponding first RF processing circuit 222 and first antenna 130, so as to avoid interfering with the Bluetooth signal reception of the second RF processing circuit 224 and the second antenna 230.

During time periods in which RF interference would not occur, the packet traffic arbitration circuit 117 may permit both the first media access control circuit 154 and the second media access control circuit 164 to simultaneously access the RF circuit 120. For example, during a time period in which both the first media access control circuit 154 and the second media access control circuit 164 only receive Bluetooth signals through the RF circuit 120, the packet traffic arbitration circuit 117 may permit the first media access control circuit 154 to receive Bluetooth signals from a related Bluetooth slave device through the first RF processing circuit 222 and the first antenna 130, while simultaneously permitting the second media access control circuit 164 to receive Bluetooth signals from another related Bluetooth slave device through the second RF processing circuit 224 and the second antenna 230. For another example, during a time period in which both the first media access control circuit 154 and the second media access control circuit 164 only transmit Bluetooth signals through the RF circuit 120, the packet traffic arbitration circuit 117 may permit the first media access control circuit 154 to transmit Bluetooth signals to a related Bluetooth slave device through the first RF processing circuit 222 and the first antenna 130, while simultaneously permitting the second media access control circuit 164 to transmit Bluetooth signals to another related Bluetooth slave device through the second RF processing circuit 224 and the second antenna 230.

In other words, the architecture in the embodiment of FIG. 2, in which dual RF processing circuits operate in conjunction with dual antennas, may enable the first Bluetooth processing circuit 115 and the second Bluetooth processing circuit 116 to have respective independent signal transmission paths at the physical layer, without sharing the same antenna as in the embodiment of FIG. 1. By performing scheduling coordination through the packet traffic arbitration circuit 117, the issue of RF interference may be effectively avoided, which may in turn ensure that the Bluetooth communication system 100 has good Bluetooth connection quality.

Therefore, when the control circuit 118 controls the first Bluetooth processing circuit 115 and the second Bluetooth processing circuit 116 to operate simultaneously, both the first Bluetooth processing circuit 115 and the second Bluetooth processing circuit 116 may significantly reduce the time-slot queuing wait time caused by sharing the same antenna, which may in turn effectively improve the overall Bluetooth transmission bandwidth and data throughput of the Bluetooth communication system 100. In high-load application scenarios that require simultaneous streaming of multiple channels of high-quality audio data (or high-quality video data), the architecture of the Bluetooth communication system 100 disclosed in FIG. 2 may exhibit superior operational performance and may provide more desirable multi-channel audio or multi-channel video streaming quality.

The foregoing descriptions regarding the connection relationships, implementations, operations, and related advantages of other components in FIG. 1 are also applicable to the embodiment of FIG. 2. For the sake of brevity, the descriptions are not repeated here.

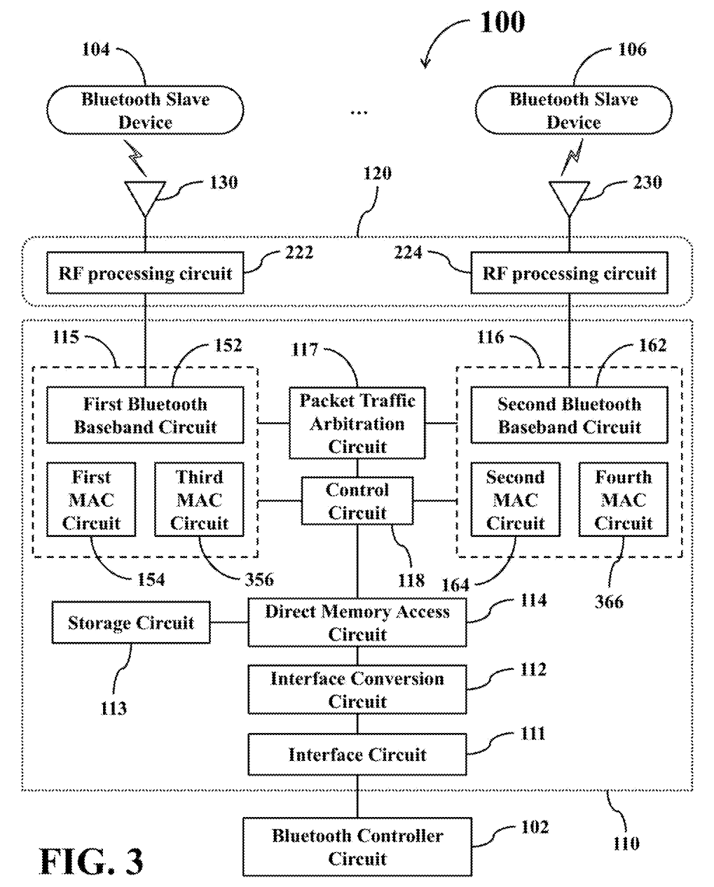

Please refer to FIG. 3, which shows a simplified functional block diagram of a Bluetooth communication system 100 according to a third embodiment of the present disclosure. The present embodiment is based on the architecture of the embodiment of FIG. 2, with hardware expansion performed on the first Bluetooth processing circuit 115 and/or the second Bluetooth processing circuit 116, such that the first Bluetooth processing circuit 115 and/or the second Bluetooth processing circuit 116 may have a dual-mode operating capability, so as to further improve the application flexibility of the Bluetooth controller circuit 110.

For example, in one embodiment, the first Bluetooth processing circuit 115 may further comprise a third media access control circuit 356, which is communicatively coupled with the first Bluetooth baseband circuit 152, and may be arranged to operably perform packet formatting and time-slot timing control compliant with the Bluetooth Low Energy (BLE) specifications, and may access the first RF processing circuit 222 in the RF circuit 120 through the first Bluetooth baseband circuit 152. In such a situation, the first Bluetooth baseband circuit 152 in the first Bluetooth processing circuit 115 may be configured to operably support two modulation modes (i.e., a modulation mode of the BR/EDR specifications and a modulation mode of the BLE specifications) and two frequency-hopping mechanisms (i.e., a frequency-hopping mechanism of the BR/EDR specifications and a frequency-hopping mechanism of the BLE specifications), such that the first media access control circuit 154 and the third media access control circuit 356 may simultaneously or alternately access the first RF processing circuit 222 in the RF circuit 120 through the first Bluetooth baseband circuit 152.

In such a situation, the packet traffic arbitration circuit 117 may be configured to operably, based on the traffic priority configuration command generated by the control circuit 118, coordinate the schedules at which the first media access control circuit 154, the second media access control circuit 164, and the third media access control circuit 356 transmit and receive Bluetooth signals through the RF circuit 120, so as to suppress RF interference. For example, when the second media access control circuit 164 receives Bluetooth signals from a related Bluetooth slave device through the corresponding second RF processing circuit 224 and second antenna 230 within a third target time period (e.g., a third target time-slot), the packet traffic arbitration circuit 117 may prevent the first media access control circuit 154 and the third media access control circuit 356 from transmitting Bluetooth signals through the corresponding first RF processing circuit 222 and first antenna 130, so as to avoid interfering with the Bluetooth signal reception of the second RF processing circuit 224 and the second antenna 230. Similarly, when the first media access control circuit 154 or the third media access control circuit 356 receives Bluetooth signals from a related Bluetooth slave device through the corresponding first RF processing circuit 222 and first antenna 130 within a fourth target time period (e.g., a fourth target time-slot), the packet traffic arbitration circuit 117 may prevent the second media access control circuit 164 from transmitting Bluetooth signals through the corresponding second RF processing circuit 224 and second antenna 230, so as to avoid interfering with the Bluetooth signal reception of the first RF processing circuit 222 and the first antenna 130.

In another embodiment, in addition to the first Bluetooth processing circuit 115 comprising the aforementioned third media access control circuit 356, the second Bluetooth processing circuit 116 may further comprise a fourth media access control circuit 366, which is communicatively coupled with the second Bluetooth baseband circuit 162, and may be arranged to operably perform packet formatting and time-slot timing control compliant with the Bluetooth Low Energy (BLE) specifications, and may access the second RF processing circuit 224 in the RF circuit 120 through the second Bluetooth baseband circuit 162. In such a situation, the second Bluetooth baseband circuit 162 in the second Bluetooth processing circuit 116 may be configured to operably support two modulation modes (i.e., a modulation mode of the BR/EDR specifications and a modulation mode of the BLE specifications) and two frequency-hopping mechanisms (i.e., a frequency-hopping mechanism of the BR/EDR specifications and a frequency-hopping mechanism of the BLE specifications), such that the second media access control circuit 164 and the fourth media access control circuit 366 may simultaneously or alternately access the second RF processing circuit 224 in the RF circuit 120 through the second Bluetooth baseband circuit 162.

In such a situation, the packet traffic arbitration circuit 117 may be configured to operably, based on the traffic priority configuration command generated by the control circuit 118, coordinate the schedules at which the first media access control circuit 154, the second media access control circuit 164, the third media access control circuit 356, and the fourth media access control circuit 366 transmit and receive Bluetooth signals through the RF circuit 120, so as to suppress RF interference. For example, when the first media access control circuit 154 or the third media access control circuit 356 receives Bluetooth signals from a related Bluetooth slave device through the corresponding first RF processing circuit 222 and first antenna 130 within a fifth target time period (e.g., a fifth target time-slot), the packet traffic arbitration circuit 117 may prevent the second media access control circuit 164 and the fourth media access control circuit 366 from transmitting Bluetooth signals through the corresponding second RF processing circuit 224 and second antenna 230, so as to avoid interfering with the Bluetooth signal reception of the first RF processing circuit 222 and the first antenna 130. Similarly, when the second media access control circuit 164 or the fourth media access control circuit 366 receives Bluetooth signals from a related Bluetooth slave device through the corresponding second RF processing circuit 224 and second antenna 230 within a sixth target time period (e.g., a sixth target time-slot), the packet traffic arbitration circuit 117 may prevent the first media access control circuit 154 and the third media access control circuit 356 from transmitting Bluetooth signals through the corresponding first RF processing circuit 222 and first antenna 130, so as to avoid interfering with the Bluetooth signal reception of the second RF processing circuit 224 and the second antenna 230.

As may be appreciated from the foregoing descriptions, the first Bluetooth processing circuit 115 and/or the second Bluetooth processing circuit 116 in the embodiment of FIG. 3 has a dual-mode operating capability, and may support both the Classic Bluetooth (or Legacy Bluetooth) technology and the Bluetooth Low Energy (BLE) technology, which may significantly improve the application flexibility of the Bluetooth controller circuit 110.

The foregoing descriptions regarding the connection relationships, implementations, operations, and related advantages of other components in FIGS. 1 and 2 are also applicable to the embodiment of FIG. 3. For the sake of brevity, the descriptions are not repeated here.

Please note that the circuit architectures of the Bluetooth communication system 100 in FIGS. 1 - 3 mentioned above are merely exemplary embodiments, and are not intended to limit the actual implementations of the present disclosure.

For example, as long as the control circuit 118 has sufficient computing capability, in certain specific low-speed application solutions or simplified circuit requirements, the interface conversion circuit 112 may be omitted, and the control circuit 118 may, by means of firmware, directly perform protocol translation and format conversion on raw data from the interface circuit 111.

For another example, in certain ASIC circuit architectures, the logic functions of the packet traffic arbitration circuit 117 may be integrated into the control circuit 118, such that the control circuit 118 may directly coordinate the timings at which the first Bluetooth processing circuit 115 and the second Bluetooth processing circuit 116 access the RF circuit 120.

As may be appreciated from the foregoing descriptions of the embodiments of FIGS. 1 - 3, by configuring two sets of independent Bluetooth processing circuits (i.e., the aforementioned first Bluetooth processing circuit 115 and second Bluetooth processing circuit 116) within the Bluetooth controller circuit 110, the upper limit on the number of Bluetooth slave devices with which the Bluetooth host device 102 may simultaneously maintain Bluetooth connections may break through the existing technical bottleneck and may be doubled from seven to as many as fourteen. If more sets of independent Bluetooth processing circuits may be configured in the Bluetooth controller circuit 110, the upper limit on the number of Bluetooth slave devices with which the Bluetooth host device 102 may simultaneously maintain Bluetooth connections may be further increased.

Furthermore, the Bluetooth host device 102 does not need to modify the hardware architecture of the Bluetooth host device 102 in order to simultaneously maintain Bluetooth connections with more than seven Bluetooth slave devices through the Bluetooth controller circuit 110. For manufacturers of the Bluetooth host device 102, this feature may significantly reduce the cost and engineering difficulty of incorporating the Bluetooth controller circuit 110.

In addition, during a process in which the Bluetooth host device 102 conducts Bluetooth transmissions with one or more Bluetooth slave devices through the Bluetooth controller circuit 110, the control circuit 118 may further dynamically perform a Bluetooth connection redistribution operation according to the current Bluetooth packet traffic load, the current transmission bandwidth requirement, the current number of simultaneously connected Bluetooth slave devices, and/or the current circuit temperature of the Bluetooth controller circuit 110.

When the current Bluetooth packet traffic load of the Bluetooth controller circuit 110 is higher than the first predetermined threshold, the current transmission bandwidth requirement is higher than the first predetermined bandwidth, the current number of simultaneously connected Bluetooth slave devices is greater than the first predetermined number, and/or the current circuit temperature is higher than the first predetermined temperature, the Bluetooth connection redistribution operation performed by the control circuit 118 may avoid the Bluetooth traffic load of the Bluetooth controller circuit 110 from being excessively concentrated on one of the Bluetooth processing circuits. Therefore, the total transmission bandwidth and/or the total data throughput of the Bluetooth controller circuit 110 may be increased, and the operational performance of the Bluetooth controller circuit 110 may be effectively improved.

On the other hand, when the current Bluetooth packet traffic load of the Bluetooth controller circuit 110 is lower than the second predetermined threshold, the current transmission bandwidth requirement is lower than the second predetermined bandwidth, the current number of simultaneously connected Bluetooth slave devices is less than the second predetermined number, and/or the current circuit temperature is lower than the second predetermined temperature, the control circuit 118 may again perform the Bluetooth connection redistribution operation, so as to alternately use one of the first Bluetooth processing circuit 115 and the second Bluetooth processing circuit 116 to bear all of the Bluetooth connections in a sequential manner, thereby saving the overall power consumption of the Bluetooth controller circuit 110.

Furthermore, the Bluetooth connection redistribution operation performed by the control circuit 118 may further effectively balance the utilization rates of both the first Bluetooth processing circuit 115 and the second Bluetooth processing circuit 116, and/or balance the thermal distribution of the Bluetooth controller circuit 110, and therefore may effectively avoid or mitigate the issue of local overheating occurring in the Bluetooth controller circuit 110, which may in turn ensure the reliability of the Bluetooth controller circuit 110 and may extend the usable lifespan of the Bluetooth controller circuit 110.

As disclosed in the embodiment of FIG. 2, when the Bluetooth communication system 100 adopts the architecture in which dual RF processing circuits operate in conjunction with dual antennas, the overall Bluetooth transmission bandwidth and data throughput of the Bluetooth communication system 100 may be effectively improved.

As disclosed in the embodiment of FIG. 3, when the first Bluetooth processing circuit 115 and/or the second Bluetooth processing circuit 116 has a dual-mode operating capability that may support both the Classic Bluetooth (or Legacy Bluetooth) technology and the Bluetooth Low Energy (BLE) technology, the application flexibility of the Bluetooth controller circuit 110 may be significantly improved.

Certain terms are used throughout the description and the claims to refer to particular components. One skilled in the art appreciates that a component may be referred to by different names. This disclosure does not intend to distinguish between components that differ in name but not in function. In the description and in the claims, the term “comprise” is used in an open-ended fashion, and thus should be interpreted to mean “include, but not limited to.” The term “couple” is intended to encompass any indirect or direct connection. Therefore, if this disclosure mentions that a first element is coupled with a second element, it means that the first element may be directly or indirectly connected to the second element through electrical connections, wireless communications, optical communications, or other signal connections with/without other intermediate devices or connection means.

The term “and/or” may comprise any and all combinations of one or more of the associated listed items. In addition, the singular forms “a,” “an,” and “the” herein are intended to comprise the plural forms as well, unless the context clearly indicates otherwise.

Other embodiments of the invention will be apparent to those skilled in the art from consideration of the specification and practice of the invention disclosed herein. It is intended that the specification and examples be considered as exemplary only, with a true scope and spirit of the invention indicated by the following claims.

What is claimed is:

1. A Bluetooth controller circuit (110) for serving as a communication bridge between a Bluetooth host device (102) and a plurality of Bluetooth slave devices (104, 106), the plurality of Bluetooth slave devices (104, 106) comprising a first Bluetooth slave device (104) and a second Bluetooth slave device (106), the Bluetooth controller circuit (110) comprising:
an interface circuit (111), arranged to operably communicatively couple with the Bluetooth host device (102) and conduct signal transmissions with the Bluetooth host device (102), and arranged to operably perform a physical-layer signal processing operation so as to cause the Bluetooth host device (102) to identify the Bluetooth controller circuit (110) as a single Bluetooth controller;
an interface conversion circuit (112), communicatively coupled with the interface circuit (111), and arranged to operably convert data from the Bluetooth host device (102) into another data format so as to generate target-format data;
a storage circuit (113);
a direct memory access circuit (114), communicatively coupled with the interface conversion circuit (112) and the storage circuit (113), and arranged to operably store the target-format data generated by the interface conversion circuit (112) into the storage circuit (113), and to perform various data transfer operations between the storage circuit (113) and internal components of the Bluetooth controller circuit (110);
a first Bluetooth processing circuit (115), communicatively coupled with a radio frequency (RF) circuit (120), and arranged to operably conduct Bluetooth communications with the first Bluetooth slave device (104) through the RF circuit (120);
a second Bluetooth processing circuit (116), communicatively coupled with the RF circuit (120), and arranged to operably conduct Bluetooth communications with the second Bluetooth slave device (106) through the RF circuit (120);
a packet traffic arbitration circuit (117), communicatively coupled with the first Bluetooth processing circuit (115) and the second Bluetooth processing circuit (116), and arranged to operably coordinate timings at which the first and second Bluetooth processing circuits (115, 116) access the RF circuit (120); and
a control circuit (118), communicatively coupled with the interface circuit (111), the interface conversion circuit (112), the storage circuit (113), the direct memory access circuit (114), the first Bluetooth processing circuit (115), the second Bluetooth processing circuit (116), and the packet traffic arbitration circuit (117), and arranged to operably control operations of the interface circuit (111), the interface conversion circuit (112), the storage circuit (113), the direct memory access circuit (114), the first Bluetooth processing circuit (115), the second Bluetooth processing circuit (116), and the packet traffic arbitration circuit (117);
wherein the control circuit (118) is further arranged to operably monitor traffic loads of multiple Bluetooth connections between the Bluetooth controller circuit (110) and the plurality of Bluetooth slave devices (104, 106), and to generate a traffic priority configuration command corresponding to the multiple Bluetooth connections.

2. The Bluetooth controller circuit (110) of claim 1, wherein the first Bluetooth processing circuit (115) comprises:
a first Bluetooth baseband circuit (152), communicatively coupled with the RF circuit (120), and arranged to operably perform a baseband signal processing; and
a first media access control circuit (154), communicatively coupled with the first Bluetooth baseband circuit (152), and arranged to operably perform a packet formatting and a time-slot timing control compliant with Bluetooth Basic Rate (BR) and Enhanced Data Rate (EDR) specifications, so as to access the RF circuit (120) through the first Bluetooth baseband circuit (152);
wherein the second Bluetooth processing circuit (116) comprises:
a second Bluetooth baseband circuit (162), communicatively coupled with the RF circuit (120), and arranged to operably perform a baseband signal processing; and
a second media access control circuit (164), communicatively coupled with the second Bluetooth baseband circuit (162), and arranged to operably perform a packet formatting and a time-slot timing control compliant with the BR and EDR specifications, so as to access the RF circuit (120) through the second Bluetooth baseband circuit (162).

3. The Bluetooth controller circuit (110) of claim 2, wherein the control circuit (118) is further arranged to operably instruct the first media access control circuit (154) and the second media access control circuit (164) to respectively use two sets of independent Active Member Address allocation logics, such that the Bluetooth controller circuit (110) is enabled to simultaneously maintain Bluetooth connections with more than seven Bluetooth slave devices among the plurality of Bluetooth slave devices (104, 106).

4. The Bluetooth controller circuit (110) of claim 2, wherein the RF circuit (120) is communicatively coupled with a single antenna (130), and the first Bluetooth processing circuit (115) and the second Bluetooth processing circuit (116) share the single antenna (130) through the RF circuit (120);
wherein the packet traffic arbitration circuit (117) is configured to operably, based on the traffic priority configuration command, employ a time division multiplexing (TDM) scheme to control access rights of both the first media access control circuit (154) and the second media access control circuit (164) with respect to the RF circuit (120).

5. The Bluetooth controller circuit (110) of claim 2, wherein the RF circuit (120) comprises a first RF processing circuit (222) and a second RF processing circuit (224), which are respectively communicatively coupled with a first antenna (130) and a second antenna (230);
wherein the first Bluetooth baseband circuit (152) is communicatively coupled with the first RF processing circuit (222), and the second Bluetooth baseband circuit (162) is communicatively coupled with the second RF processing circuit (224);
wherein the packet traffic arbitration circuit (117) is configured to operably, based on the traffic priority configuration command, coordinate schedules at which the first media access control circuit (154) and the second media access control circuit (164) transmit and receive Bluetooth signals through the RF circuit (120), so as to suppress RF interference.

6. The Bluetooth controller circuit (110) of claim 5, wherein the first Bluetooth processing circuit (115) further comprises:
a third media access control circuit (356), communicatively coupled with the first Bluetooth baseband circuit (152), and arranged to operably perform a packet formatting and a time-slot timing control compliant with Bluetooth Low Energy specifications, so as to access the RF circuit (120) through the first Bluetooth baseband circuit (152);
wherein the first Bluetooth baseband circuit (152) is configured to operably support a plurality of modulation modes, such that the first media access control circuit (154) and the third media access control circuit (356) are enabled to simultaneously or alternately access the RF circuit (120) through the first Bluetooth baseband circuit (152).

7. The Bluetooth controller circuit (110) of claim 6, wherein the packet traffic arbitration circuit (117) is further configured to operably, based on the traffic priority configuration command, coordinate schedules at which the first media access control circuit (154), the second media access control circuit (164), and the third media access control circuit (356) transmit and receive Bluetooth signals through the RF circuit (120), so as to suppress RF interference.

8. The Bluetooth controller circuit (110) of claim 6, wherein the second Bluetooth processing circuit (116) further comprises:
a fourth media access control circuit (366), communicatively coupled with the second Bluetooth baseband circuit (162), and arranged to operably perform a packet formatting and a time-slot timing control compliant with the Bluetooth Low Energy specifications, so as to access the RF circuit (120) through the second Bluetooth baseband circuit (162);
wherein the second Bluetooth baseband circuit (162) is configured to operably support a plurality of modulation modes, such that the second media access control circuit (164) and the fourth media access control circuit (366) are enabled to simultaneously or alternately access the RF circuit (120) through the second Bluetooth baseband circuit (162).

9. The Bluetooth controller circuit (110) of claim 8, wherein the packet traffic arbitration circuit (117) is further configured to operably, based on the traffic priority configuration command, coordinate schedules at which the first media access control circuit (154), the second media access control circuit (164), the third media access control circuit (356), and the fourth media access control circuit (366) transmit and receive Bluetooth signals through the RF circuit (120), so as to suppress RF interference.

10. The Bluetooth controller circuit (110) of claim 2, wherein the control circuit (118) is further configured to operably dynamically perform a Bluetooth connection redistribution operation between the first Bluetooth processing circuit (115) and the second Bluetooth processing circuit (116), the Bluetooth connection redistribution operation comprising:
when at a first target time point a current Bluetooth packet traffic load of the Bluetooth controller circuit (110) is higher than a first predetermined threshold, a current transmission bandwidth requirement is higher than a first predetermined bandwidth, a current number of simultaneously connected Bluetooth slave devices is greater than a first predetermined number, or a current circuit temperature is higher than a first predetermined temperature, performing a load balancing operation on the multiple Bluetooth connections between the first Bluetooth processing circuit (115) and the second Bluetooth processing circuit (116), so as to increase a total transmission bandwidth or a total data throughput of the Bluetooth controller circuit (110); and
when at a second target time point a current Bluetooth packet traffic load of the Bluetooth controller circuit (110) is lower than a second predetermined threshold, a current transmission bandwidth requirement is lower than a second predetermined bandwidth, a current number of simultaneously connected Bluetooth slave devices is less than a second predetermined number, or a current circuit temperature is lower than a second predetermined temperature, alternately using one of the first Bluetooth processing circuit (115) and the second Bluetooth processing circuit (116) to bear all Bluetooth connections in a sequential manner, so as to balance utilization rates of the first Bluetooth processing circuit (115) and the second Bluetooth processing circuit (116), or to balance a thermal distribution of the Bluetooth controller circuit (110).
